(19) United States
(12) Patent Application Publication
(10) Pub. No.: US 2001/0016282 A1
(43) Pub. Date: Aug. 23, 2001

(54) Gastight-sealed alkaline storage battery in the form of a button cell

(75) Inventors: Manfred Kilb, Rainau-Schwabsberg (DE); Eduard Pytlik, Ellwangen (DE); Dejan Ilic, Ellwangen (DE); German Schulz, Ellwangen (DE); Thomas Koke, Aalen (DE)

Correspondence Address: IP Department, Schnader Harrison Segal & Lewis, 36th Floor, 1600 Market Street, Philadelphia, PA, 19103, US

(73) Assignee: Varta Geratebatterie, GmbH

(21) Appl. No.: 09/774,827

(22) Filed: Jan. 29, 2001

(30) Foreign Application Priority Data
Feb. 23, 2000 (DE) 100 08 193.2

(51) Int. Cl. H01M 4/58; H01M 4/80; H01M 10/34

(52) U.S. Cl. 429/218.2; 429/59; 429/66; 429/235

(57) ABSTRACT

A gastight-sealed alkaline nickel/metal hydride storage battery in the form of a button cell having positive and negative electrodes which are arranged in the cell case and separated by a separator. Both electrodes have a support and conductor framework, which consists of a porous metal foam or metal felt, the positive electrode having a metallic region which is free of active material on the side bearing against the cell case.

This region which is free of active material extends over 5 to 15%, preferably 10%, of the total thickness of the electrode. At least one of the electrodes has a central cut-out, the volume of which is 5 to 20%, preferably approximately 10 %, of the electrode volume.

### FIELD OF THE INVENTION

This invention relates to a gastight-sealed alkaline storage battery in the form of a button cell, having positive and negative electrodes which are arranged in the cell case and separated by a separator.

### BACKGROUND

The case of a standard button cell is formed by a cup-shaped bottom part and a cover made from nickel-coated steel sheet. The bottom part first receives the positive electrode, followed by an alkali-resistant plastic material as a separator, on top of which the negative electrode is arranged. The electrodes and separator are impregnated with electrolyte. Between the negative electrode and the cover there is a spring which produces close contact between the electrodes and the cell case. The cell cup and cover are insulated from one another by a plastic seal. A sealed closure is achieved by flanging the edge of the cup and pressing it securely in place.

Typical button cell electrodes are mass electrodes which consist of a dry mixture pressed into tablets. The finished tablets require a conductive external reinforcement in the form of a basket of woven nickel wire. Therefore, mass electrodes of this nature are complex to produce.

EP 658 949 B1 describes a button cell in which at least the positive electrode has a support and conductor framework which consists of a porous metal foam or metal felt. The use of a foam material makes it possible to dispense with the addition of conductor means, such as nickel powder, so that higher capacities can be achieved. Particularly in the case of a nickel/cadmium button cell, it is proposed in EP 658 949 B1 for the negative electrode also to be produced on the basis of a foam support material.

Accordingly, it would be advantageous to provide button cells which are distinguished by an extremely high load-bearing capacity with a significantly reduced overall height while being much easier to assemble and manufacture.

### SUMMARY OF THE INVENTION

The invention relates to a gastight-sealed alkaline nickel/metal hydride button cell storage battery including positive and negative electrodes arranged in a button cell case and separated by a separator, wherein both electrodes have a support and conductor framework, which includes a porous metal foam or metal felt, and wherein the positive electrode, on a side bearing against the cell case, has a metallic region which is free of active material.

### BRIEF DESCRIPTION OF THE DRAWINGS

The subject matter of the invention is explained in more detail below with reference to FIGS. 1 to 3.

FIG. 1 is a cross section view taken through a cell according to the invention.

FIGS. 2a and 2b show a negative electrode used in this cell, in plan view in FIG. 2a and in cross section in FIG. 2b.

FIGS. 3a and 3b show a flat spring which is provided between cell cover and the set of electrodes, from above in FIG. 3a and from below in FIG. 3b.

### DETAILED DESCRIPTION

The following description is intended to refer to specific embodiments of the invention illustrated in the drawings and is not intended to define or limit the invention, other than in the appended claims. Also, the drawings are not to scale and various dimensions and proportions are contemplated.

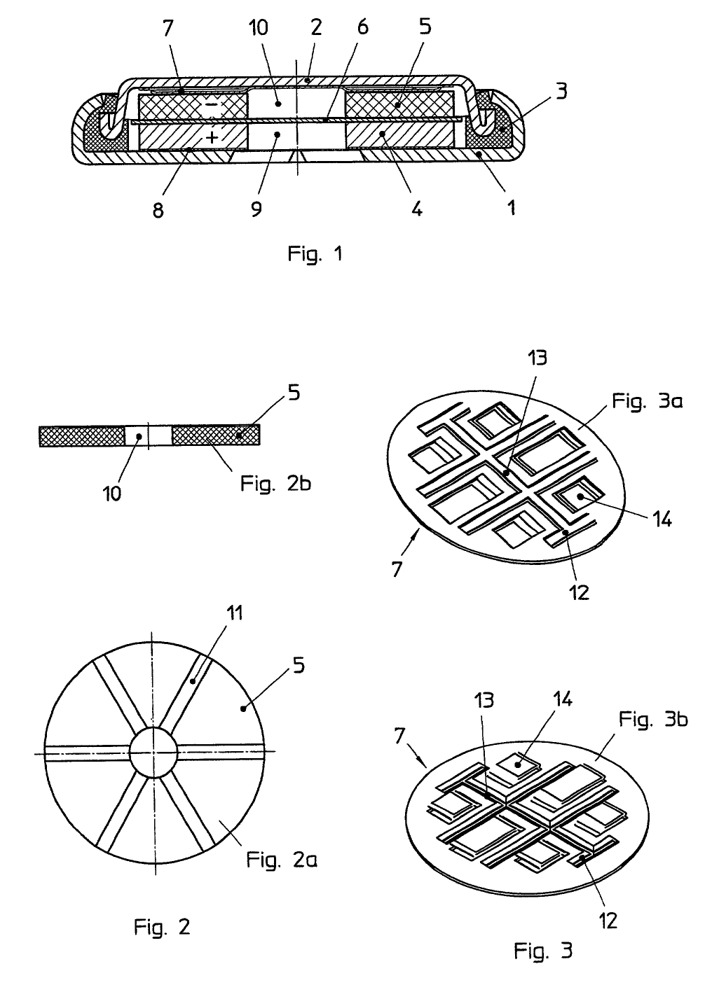

Turning now to the drawings in general and FIG. 1 in particular, button cell 100 comprises a cell cup 1 and a cell cover 2, between which an electrically insulating seal 3 is arranged. The positive electrode 4 and the negative electrode 5 are situated inside cell 100. The separator 6 is provided between the electrodes 4 and 5. Also, a spring 7 is arranged above the negative electrode 5. Spring 7 exerts a force on the set of electrodes and, therefore, ensures that the electrodes are provided with a good electrical connection to the parts of the cell.

The positive electrode has a nickel hydroxide material as its active compound, while the negative electrode has a H₂ storage material as its active compound. Both the positive and negative electrodes have a nickel foam material as the supporting framework. According to the invention, the nickel foam support framework of the positive electrode 4 is designed such that the framework is free of positive active compound on the side which bears against the cell cup 1. This positive electrode is produced such that a nickel foam, which may have been prepressed to a selected size, is impregnated on one side with a nickel hydroxide paste in a manner that about 5 to about 15%, preferably about 100%, of the thickness of the electrode intended to be fitted in the cell is free of active compound in the region 8 at which the electrode bears against the cell cup.

A standard nickel foam of high porosity which has been precompacted to a selected thickness and into which an aqueous paste of nickel hydroxide powder, possibly with further metal additives, is introduced by one-sided pasting, and used to produce the positive electrode 4. Suitable additives are, in particular, cobalt compounds or zinc compounds. The nickel hydroxide should be a material with substantially spherical grains and a high solid density, as described, for example, in EP 694 981 B1. After the paste has been introduced into the foam framework, the strip is calibrated and, if appropriate, compacted to its final thickness. Then, individual electrodes which are intended to be fitted in the cell are cut from the strip.

The negative electrode 5 likewise has as its support material a metal foam framework into which a hydrogen storage alloy has been pasted. This hydrogen storage alloy fills the foam framework over its entire thickness. It is either fully impregnated into the foam framework from one side or paste is applied to the foam framework from both sides.

The H₂ storage material used may be materials of the generic type AB₅ (LaNi₅, MmNi₅) with further additional elements or materials of the generic type AB₂ (Ti₂Ni, TiNi), for example.

The positive electrode 4, which has a region 8 which bears against the cell cup 1 and according to the invention is free of active compound, is in good electrical contact with the cell cup 1 over the region which remains metallic.

According to a further configuration of the invention, the positive electrode 4 has a central cut-out 9. This central cut-out, which may be of any desired shape, but preferably in the shape of a cylinder, first serves to center and hold the electrode 4 when it is introduced into the cell cup 1 and, second, its volume is such that during installation, the supply of electrolyte which impregnates the electrode with electrolyte can be introduced into this cavity 9. The volume of this cavity 9 is about 5 to about 20% of the volume of the electrode, and is preferably about 10% of the electrode volume.

Preferably, the negative electrode 5 likewise has a cavity 10 of this type, the volume of which is dimensioned in substantially the same way.

This design of the electrodes allows the button cell according to the invention to be assembled very easily. First, the cell cover 2 is assembled with the seal 3, the spring 7 is inserted and the negative electrode 5 is introduced and centered. Then, the amount of electrolyte which is required for impregnation of the electrode is metered into the cavity 10 and the separator 6 is introduced. Finally, the positive electrode 4 is fitted, centered by means of the cut-out 9, and a supply of electrolyte is also introduced into the cavity 9 of this electrode. The electrodes and the separator absorb the supply of electrolyte which has been introduced and it is thus ensured that during assembly no electrolyte reaches the region of the seal 3, which could subsequently lead to the cell leaking. Finally, the cell cup 1 is pulled over and the edge of the cell cup 1 is flanged over the edge of the cell cover 2 with the seal 3 between them.

It is advantageous for recesses 11, as illustrated, for example, in FIG. 2a, to be arranged in the negative electrode 5 on the side facing the cell cover 2. These recesses run outwardly in the shape of a star from the cavity 10, or are formed in a hub and spoke arrangement, and ensure good gas exchange and, therefore, rapid gas consumption. The star-shaped recesses 11 may have a depth of, for example, about 0.05 to about 0.1 mm. The electrodes themselves may be very thin, on account of the use of foam material according to the invention. Their thickness may in particular be only about 0.3 to about 1 mm. The recesses have a depth of from about 5 to about 15%, preferably about 10%, of the electrode thickness.

A spring 7 is arranged above the negative electrode 5, the spring being illustrated in FIGS. 3a and 3b, which show the spring from both sides. According to the invention, a particularly flat spring 7 is used in this case, consisting of a thin nickel sheet which has ribs 12 and 13 on one side, which increase the stability of the material, and a multiplicity of flat tongues 14 on the other side, which have been bent out of the material and exert a spring action on a large part of the surface of the negative electrode 5.

The use of foam material as a support framework for both electrodes makes it possible to use, in particular, spherical nickel hydroxide as the active material for the positive electrode. Consequently, there is no need for complex impregnation processes for the electrodes and, therefore, production of the electrodes can be economically automated. The result is capacities which are about 30 to about 40% higher than those achieved with known techniques. The particular design of the positive electrode, which produces good electrical connection between the electrode and the cell case, significantly increases the load-bearing capacity of the cells. The manufacturing processes used, in the form of pasting methods, result in only slight dust production and a low energy consumption.

Compared to electrodes which are produced, for example, by rolling, the foam electrodes according to the invention exhibit a high level of stability, thus considerably improving their processibility during the production of the cells. The introduction of central cut-outs ensures that the electrodes are centered during assembly and, therefore, production is uniform. In particular, the use of electrodes of this nature makes it possible to construct extremely thin cells with thicknesses of from 0.4 to 2.6 mm total height, which is impossible with conventional electrodes.

During assembly, the electrolyte can be metered into the cavities provided in the electrodes, so that contamination to the region of the seal of the cell is avoided.

What is claimed is:

1. A gastight-sealed alkaline nickel/metal hydride button cell storage battery comprising positive and negative electrodes arranged in a button cell case and separated by a separator, wherein both electrodes have a support and conductor framework, which includes a porous metal foam or metal felt, and wherein the positive electrode, on a side bearing against the cell case, has a metallic region which is free of active material.

2. The gastight-sealed nickel/metal hydride storage battery as claimed in claim 1, wherein the region which is free of active material extends over about 5 to about 15%, of the total thickness of the positive electrode.

3. The gastight-sealed nickel/metal hydride storage battery as claimed in claim 1, wherein the region which is free of active material extends over about 10%, of the total thickness of the positive electrode.

4. The gastight-sealed nickel/metal hydride storage battery as claimed in claim 1, wherein at least one of the positive and negative electrodes has a central cut-out, the volume of which is about 5 to about 20% of the volume of the positive and negative electrode, respectively.

5. The gastight-sealed nickel/metal hydride storage battery as claimed in claim 1, wherein at least one of the positive and negative electrodes has a central cut-out, the volume of which is about 10% of the volume of the positive and negative electrode, respectively.

6. The gastight-sealed nickel/metal hydride storage battery as claimed in claim 1, wherein both of the positive and negative electrodes have a central cut-out, the volume of the central cut-out being sized to accommodate an amount of electrolyte to impregnate both of the positive and negative electrodes.

7. The gastight-sealed nickel/metal hydride storage battery as claimed in claim 1, wherein the negative electrode has recesses on a side facing the cell cover.

8. The gastight-sealed nickel/metal hydride storage battery as claimed in claim 7, wherein the recesses have a depth of about 5 to about 15% of the thickness of the negative electrode.

9. The gastight-sealed nickel/metal hydride storage battery as claimed in claim 7, wherein the recesses have a depth of about 10% of the thickness of the negative electrode.

10. The gastight-sealed nickel/metal hydride storage battery as claimed in claim 7, wherein the recesses are formed in a star or spoke arrangement.

11. The gastight-sealed nickel/metal hydride storage battery as claimed in claim 1, wherein a substantially flat spring, which has a multiplicity of substantially flat spring tongues bent out of the base material, is located between the negative electrode and the cell cover.

12. The gastight-sealed nickel/metal hydride storage battery as claimed in claim 11, further comprising ribs extending outwardly from the spring in a direction opposite the tongues.
